(19) United States
(12) Patent Application Publication
(10) Pub. No.: US 2008/0043949 A1
(43) Pub. Date: Feb. 21, 2008

(54) Prepaid telephone calling card audio advertising system and method patent: system and method to broadcast a pre-recorded audio promotional message (advertising, commercial, announcement, or other related activities) through a prepaid telephone calling card

(75) Inventor: Joemy C. Tam, Ridge, NY (US)

Correspondence Address: Joemy C. Tam, Bldg. 5, Suite 2, 3235 Route 112, Medford, NY, 11763, US

(73) Assignee: PrimaNova International, Inc., Long Island City, NY (US)

(21) Appl. No.: 11/490,580

(22) Filed: Jul. 21, 2006

(51) Int. Cl. H04M 15/00

(52) U.S. Cl. 379/114.13

(57) ABSTRACT

A system and method to deliver a pre-recorded audio broadcasted promotional message (advertising, commercial, announcement, or other related activities) to people in the public when the targeted users use a prepaid telephone calling card to make a call. As an incentive to entice users in the public to use this unique calling card, the card will be provided either FREE, sold at deep discount to the users, or credit for additional minutes in usage to other calling card that the users possess. In return, the inventors plan to collect advertising revenues from their clients to cover the expenses of producing the calling cards and the promotional messages and obtain profit. The promotional message will be short but mandatory during the first and/or each calling card usage. Once the promotional message is broadcasted, it is followed by normal usage for the remaining duration of the calling card. The system and method are universal in their application and can be used to satisfy any business or non-business clients requiring broadcasted promotional message to solicit business and/or making general announcement to the public for all purposes.

### FIELD OF THE INVENTION

The present brochure relates to the field of delivering promotional message, particularly to a system and method in broadcasting such audio promotional message (advertising, commercial, announcement, or other related activities) through a specially designed prepaid telephone calling card when the card holder is making a telephone call.

### BACKGROUND AND SUMMARY OF THE INVENTION

The conventional calling card systems require customers to either purchase a fixed dollar amount of calling time by purchasing a disposable calling card, or charging the expenses of the calls through a debit, credit, or specially designed telephone card. The followings are a brief description of the various patents, which applied to telephone calling cards in various aspects.

U.S. Pat No. 5,487,107, issued to Atkins et al., discloses a general method for processing telephone calls charged to credit cards.

U.S. Pat No. 5,504,808, issued to Hamrick, Jr., discloses a disposable debit card calling system that is secured.

U.S. Pat No. 5,530,232, issued to Taylor, discloses a multi-application data card consisting of a memory system with at least three memory banks for storing and updating data. The data are relating to at least one authorized holder of the card and at least two authorized applications of the card.

U.S. Pat No. 5,850,599, issued to Seiderman, discloses a mobile telephone with a credit card debit system. The telephone credit card calling system works along with a mobile telephone, a local mobile telephone network, and an IXC in a telecommunications network.

U.S. Pat. No. 5,916,007, issued to Klapka, discloses a method and system for customers to use a frequent shopper card as a telephone calling card.

U.S. Pat No. 5,991,748, issued to Taskett, discloses an improved system for adding funds to a prepaid remote memory account of a telephone calling card in order to continue the card usage.

However, none of the inventions and patents mentioned above, taken either singly or in any combination, is seen to describe the instant invention as claimed. To the best of the inventors' knowledge, there are no existing patents ever issued which specifically disclose a method and system of using a prepaid telephone calling card as a mean to broadcast promotional messages, when the targeted users received the calling card either free (or at deep discount, or to obtain credit for additional calling time to other calling card the users already possess) in order to exchange telephone call usage by listening to mandatory pre-recorded audio promotional messages.

### BRIEF DESCRIPTION OF THE DRAWINGS

FIG. 1 is a block diagram of the advertising telephone calling card system according to the present invention.

FIG. 2 is a flow chart of one operating format of FIG. 1.

### DETAILED DESCRIPTION OF THE INVENTION

The system and method invented by the inventors will be described below in further details with reference to the attached drawings.

The advertising prepaid telephone calling card system delivers a specific pre-recorded audio broadcasted promotional message (Advertising, Commercial, Announcement, or other related activities) for business or non-business clients of the inventors to people in the public, when the targeted users are making telephone calls with the card. The promotional message will be short but mandatory during the first and/or each calling card usage. Once the promotional message is broadcasted, it is followed by normal usage for the remaining time limit of the advertising calling card. As an incentive to entice users in the public to use the advertising calling card, the card will be provided either Free, or sold at deep discount to the users, or allow the users to obtain credit for additional calling time that the users already possess. In return, the inventors plan to collect advertising revenues from their clients to cover the expenses of producing the advertising calling cards and the promotional messages as well as make a profit. The system and method are universal in their application and can be used to satisfy any business or non-business clients requiring audio broadcasted promotional message to solicit business, making general announcement, or informing the public of certain events or activities.

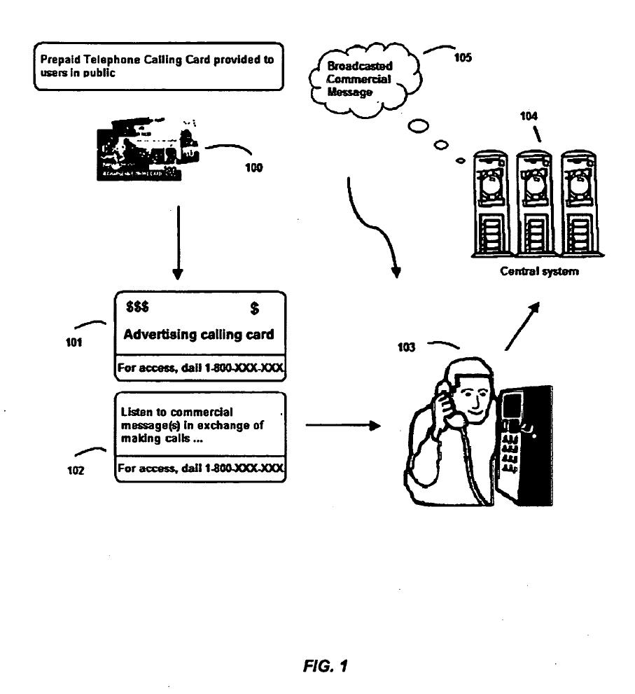

FIG. 1. is the flow chart of the advertising calling card system. The advertising prepaid calling card (100) will be provided to users in the public. On the front end of the calling card (101), the maximum calling time limit (and/or the equivalent dollar amount of calling time) will be posted, along with a title which states clearly that this is an advertising prepaid telephone card to differentiate from other regular non-advertising card. On the back end of the card (102), more details will be provided to explain that this calling card is provided either free, or at deep discount, or provide calling time credits to other calling card the users already possess. This is in exchange for the users' acceptance to listen to one or more audio broadcasted promotional messages.

After reading and accepting this information, a User (103) will dial a toll-free number to access the service provider of the inventors to make a phone call. After inputting an identification number printed in the advertising calling card, the central processing system (104) of the service provider will broadcast one or more mandatory prerecorded promotional message(s) to the user. The message is short but mandatory to the user. After listening to the message(s), the user can then make regular phone calls within the time limit indicated on the card. The procedures will be repeated next time the caller tries to use the advertising calling card to make another phone call until the maximum usage of the calling card is reached.

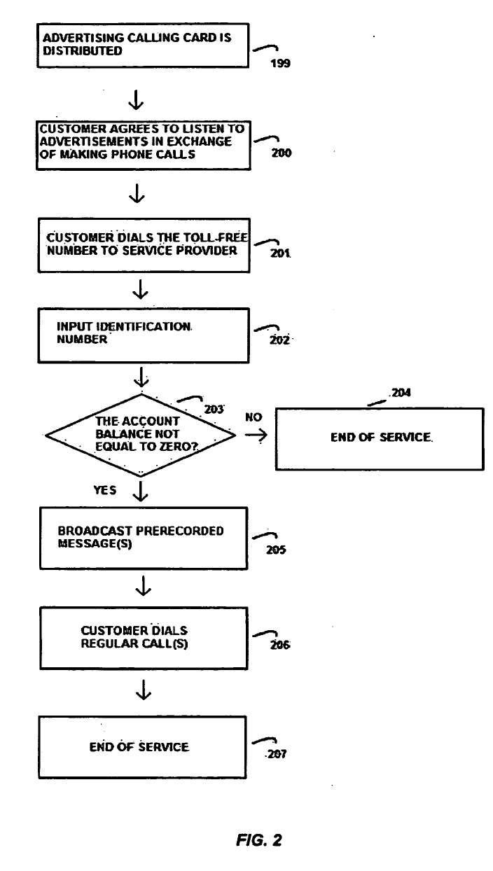

FIG. 2. shows an operating example of the advertising calling card system. The calling card is provided to users in the public (199). The user read the information provided on the card explaining that by using the card to make calls, he/she agrees to accept all the terms associated with its usage, which includes but not limited to accept listening to one or more mandatory promotional messages (200). The user then dials the toll-free number to the service provider of the inventors (201). The user is required to input an identification number to the central processing system of the service provider (202). The central system verifies the remaining time limit of the advertising calling card (203). If the card has reached its maximum time limit, the service will be terminated (204). If the card has a calling time balance not equal to zero, one or more prerecorded promotional message(s) will be sent to the caller (205). After listening to the message(s), the caller can make his/her regular call(s) within the remaining time limit of the advertising calling card (206). End of service (207) will be reached when the caller completes his/her call and/or the maximal allowable time on the calling card has been reached.

The advertising calling card indicated in FIG. 1. will have the appearance similar to other regular prepaid telephone calling card. However, on the front end of the card, the maximum allowable time limit (or equivalent dollar amount of air time) of the card and its objective will be printed. On the back end of the card, terms of usage, which identify that this calling card is associated with a promotional message, will be fully disclosed.

### Operation of the System

The audio broadcasted advertising system and method of the PrimaNova International, Inc. generally operates as follow:

When a user of the prepaid telephone calling card receives the card, the user will see from the accompanied packaging information that this prepaid telephone calling card is associated with mandatory broadcasted promotional messages. By using the calling card, it signifies the user has accepted all the terms associated with its use, which includes but not limited to listening to mandatory audio broadcasted promotional message(s) for the first and/or each subsequent usage, until the maximum limit of the allowed calling time is exceeded.

Once the user dials the toll-free number to access the system, it will automatically be connected to the central processing system of service providers of the inventors, where the pre-recorded audio broadcasted promotional message(s) will be activated. A unique identifier will differentiate which promotional message(s) will be broadcasted. Once the promotional message is broadcasted, the caller can resume normal usage by making regular phone calls for the remaining duration of the prepaid calling card.

As an incentive to entice users in the public to use the specially designed prepaid calling card, the card will be provided either free, or sold at deep discount to the users. Another alternative is that credit for additional calling time can be provided to other telephone card that the users already possess. The objective of these various approaches is to entice the users keep using this advertising calling card in exchange of calling time in making regular phone calls.

The promotional message will be short but mandatory during the first and/or each calling card usage. There is no maximal limit of time for the broadcasted promotional messages, although generally it can be from a few seconds to several minutes. In addition, the promotional message could be in any format, include but not limit to reading out a commercial message, and/or song, music, stories, or any other kind of audio advertising.

The system and method are universal in their application and can be used to satisfy any business or non-business clients requiring broadcasted promotional messages to solicit business and/or making general announcement. It is understood that our services are not limited to the list given above and any other modifications and expansions are possible without departure from the spirit of the claims given below.

What we claim is:

1. A system and method for using a specially designed prepaid telephone calling card to broadcast brief but mandatory audio promotional message(s) during the usage of the card.

2. The system and method of claim 1 wherein said the broadcasted message can be in any language, include but not limit to English, Spanish, Portuguese, Chinese, Japanese, Korean, Russian, French, German, and/or any other language that is suitable for each local market where the calling cards are used.

3. The system and method of claim 1 wherein said the broadcasted message can occur during the first and/or each subsequent use of the calling card, until the usage exceeds the maximum duration allowed by the card.

4. The system and method of claim 1 wherein said the broadcasted message can be either a regular promotional commercial, advertising, announcement, or other related activities from any business or non-business party.

5. The system and method of claim 1 wherein said the broadcasted message does not limit to a simple statement and could be in any format, include but not limit to reading out a commercial message, song, music, stories, or any other kind of audio advertising.

6. The system and method of claim 1 wherein said the broadcasted commercial or announcement has no special limit in duration, and could be from few seconds to few minutes, as dictated by the individual situation.

7. The system and method of claim 1 wherein said the prepaid telephone calling cards are either provided to the users in the public FREE, or at deep discount, or allow users to obtain calling time credit for other telephone calling card that the users already possess, in order to entice usage.

8. The system and method of claim 4 wherein said the broadcasted message can be more than one, and the messages do not necessarily need to be from the same sponsor.

9. The system and method of claim 8 wherein said the sponsor can be from either business or non-business clients.
